(19) United States
(12) Patent Application Publication
(10) Pub. No.: US 2023/0373370 A1
(43) Pub. Date: Nov. 23, 2023

(54) ADJUSTABLE HEADREST

(71) Applicant: GM Global Technology Operations LLC, Detroit, MI (US)

(72) Inventor: Mirza Grebovic, Troy, MI (US)

(21) Appl. No.: 17/748,188

(22) Filed: May 19, 2022

(51) Int. Cl. B60N 2/809

(52) U.S. Cl. CPC B60N 2/809; B60N 2002/899

(57) ABSTRACT

A vehicle seat includes a seat base, and a seat back connected to the seat base. The seat back includes an adjustable top pad having a first pad element and a second pad element. The first pad element and the second pad element are selectively moveable to accommodate one of a head protection device and a neck protection device.

The subject disclosure relates to the art of vehicles and, more particularly to an adjustable headrest that accommodates a helmeted driver.

Most, if not all, production vehicles include multiple head restraints or headrests. That is, each seating position includes a corresponding headrest. The headrest is designed to restrict rearward excursions of a driver or passenger head that may result from a sudden acceleration force. In many cases, the sudden acceleration force is caused by a rear collision. Rearward excursions of the head could result in a head or neck injury to the driver or passenger.

A typical head rest is vertically height adjustable so as to accommodate a wide range of driver/passenger body types. In some cases, the headrest may be fore-to-aft adjustable. In any case, a production vehicle headrest is not designed to accommodate both non-helmeted and helmeted drivers particularly a driver wearing a head and neck support or HANS device. Certain production vehicles are being taken to tracks and driven for enjoyment and/or competition. When driven on a track, the driver is required to wear a helmet. Current headrest designs interferer with helmets and HANS devices worn by drivers. Accordingly, it is desirable to provide a headrest that is adjustable to not only accommodate a wide array of users but also users with and without a helmet and/or HANS device.

### SUMMARY

In accordance with a non-limiting example, a vehicle seat includes a seat base, and a seat back connected to the seat base. The seat back includes an adjustable top pad having a first pad element and a second pad element. The first pad element and the second pad element are selectively moveable to accommodate one of a head protection device and a neck protection device.

In addition to one or more of the features described herein the first pad element and the second pad element are selectively vertically shiftable on the seat back.

In addition to one or more of the features described herein the first pad element includes an upper end, a lower end, and inner edge, and an outer edge, and the second pad element includes an upper end portion, a lower end portion, an inner edge portion, and an outer edge portion, the first pad element being moveable relative to the second pad element along one axis.

In addition to one or more of the features described herein the first pad element is moveable relative to the second pad element along two axes.

In addition to one or more of the features described herein the first pad element and the second pad element are rotatable about the upper end and the upper end portion to separate the lower end and the lower end portion.

In addition to one or more of the features described herein the first pad element and the second pad element are shiftable along the seat back creating a gap between the inner edge and the inner edge portion.

In addition to one or more of the features described herein the first pad element and the second pad element is rotatable relative to the seat back creating the gap between the outer edge and the seat back and the outer edge portion and the seat back.

In addition to one or more of the features described herein a manual actuator is connected to the adjustable top pad, the manual actuator releasing the first pad element and the second pad element to move along the adjustable top pad.

In addition to one or more of the features described herein an adjustment controller is operatively connected to the first pad element and the second pad element.

In addition to one or more of the features described herein an actuator is mounted to the vehicle seat, the actuator being connected to the adjustment controller to selectively shift the first pad element and the second pad element on the adjustable top pad.

In accordance with another non-limiting example, a vehicle includes a plurality of wheels and a body supported by the plurality of wheels. The body includes a passenger compartment. A seat is arranged in the passenger compartment. The seat includes a seat base and a seat back connected to the seat base. The seat back includes an adjustable top pad having a first pad element and a second pad element. The first pad element and the second pad element are selectively moveable to accommodate one of a head protection device and a neck protection device.

In addition to one or more of the features described herein the first pad element and the second pad element are selectively vertically shiftable on the seat back.

In addition to one or more of the features described herein the first pad element includes an upper end, a lower end, and inner edge, and an outer edge, and the second pad element includes an upper end portion, a lower end portion, an inner edge portion, and an outer edge portion, the first pad element being moveable relative to the second pad element along one axis.

In addition to one or more of the features described herein the first pad element is moveable relative to the second pad element along two axes.

In addition to one or more of the features described herein the first pad element and the second pad element are rotatable about the upper end and the upper end portion to separate the lower end and the lower end portion.

In addition to one or more of the features described herein the first pad element and the second pad element are shiftable along the adjustable top pad creating a gap between the inner edge and the inner edge portion.

In addition to one or more of the features described herein the first pad element and the second pad element is rotatable relative to the seat back creating the gap between the outer edge and the seat back and the outer edge portion and the seat back.

In addition to one or more of the features described herein a manual actuator is connected to the adjustable top pad, the manual actuator releasing the first pad element and the second pad element to move along the seat back.

In addition to one or more of the features described herein an adjustment controller is operatively connected to the first pad element and the second pad element.

In addition to one or more of the features described herein an actuator is mounted to the vehicle seat, the actuator being connected to the adjustment controller to selectively shift the first pad element and the second pad element on the seat back.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a vehicle including a seat having an adjustable headrest, in accordance with a non-limiting example;

FIG. 2 is a perspective view of a vehicle seat having a seat back including an adjustable headrest, in accordance with a non-limiting example;

FIG. 3 is a plan view of the adjustable headrest in an adjusted configuration, in accordance with a non-limiting example;

FIG. 4 is a plan view of the adjustable headrest in an adjusted configuration, in accordance with another non-limiting example;

FIG. 5 is a plan view of the adjustable headrest in an adjusted configuration, in accordance with yet another non-limiting example;

FIG. 6 is a top view of the vehicle seat back of FIG. 2, in accordance with a non-limiting example;

FIG. 7 is a top view of the vehicle seat back of FIG. 6 with the headrest in a first adjusted position, in accordance with a non-limiting example;

FIG. 8 is a top view of the vehicle seat back of FIG. 7 with the headrest in a second adjusted position, in accordance with a non-limiting example; and

FIG. 9 is a perspective view of a vehicle seat including the seat back with an adjustable headrest, in accordance with another non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

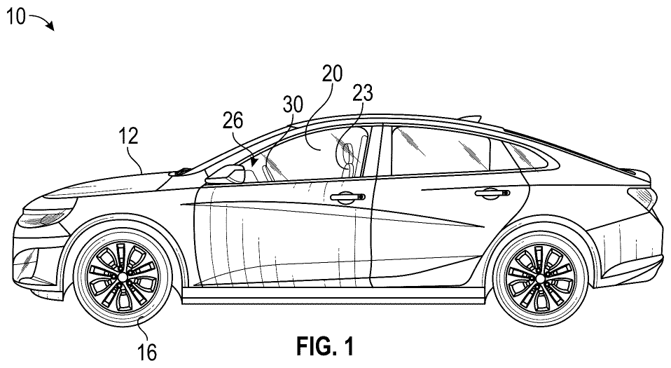

A vehicle, in accordance with a non-limiting example, is indicated generally at 10 in FIG. 1. Vehicle 10 includes a body 12 supported on a plurality of wheels 16. At least one of the plurality of wheels 16 is a steerable wheel. That is, changing a position of at least the one of the plurality of wheels 16 relative to body 12 will cause vehicle 10 to change direction. In the non-limiting example shown, both front wheels (not separately labeled) of the plurality of wheels 16 are steerable. Body 12 defines, in part, a passenger compartment 20 having seats 23 positioned behind a dashboard 26. A steering control 30 is arranged between seats 23 and dashboard 26. Steering control 30 is operated to control orientation of the steerable wheel(s).

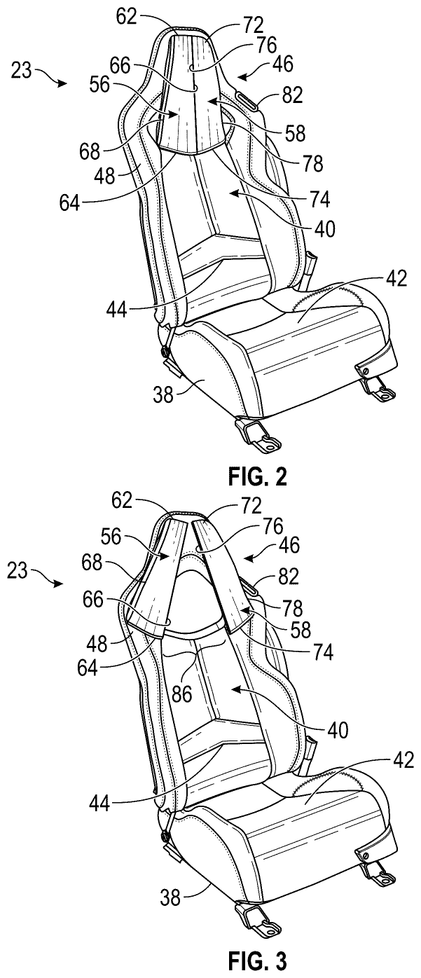

In a non-limiting example shown in FIG. 2, seat 23 includes a seat base 38 and a seat back 40. Seat back 40 includes a base portion 42 that may be pivotally connected to seat base 38 in a non-limiting example. Seat back 40 may include a lumbar support 44 and an adjustable top pad 46 that limits rearward head excursions due to acceleration forces. A side support 48 may extend about seat back 40 and provide support to adjustable top pad 46. In a non-limiting example, adjustable top pad 46 includes a first pad element 56 and a second pad element 58. As will be detailed herein, first pad element 56 and second pad element 58 are moveable relative to adjustable top pad 46 in order to accommodate a helmeted driver and/or a driver wearing a head and neck support (HANS) device (not shown).

In a non-limiting example, first pad element 56 includes an upper end 62, a lower end 64, an inner edge 66 and an outer edge 68. Inner edge 66 and outer edge 68 extend between and connect with upper end 62 and lower end 64. First pad element 56 includes a pad (not shown) covered by material (not separately labeled). The pad may be formed from a variety of materials. In a non-limiting example, second pad element 58 includes an upper end portion 72, a lower end portion 74, an inner edge portion 76, and an outer edge portion 78. Inner edge portion 76 and outer edge portion 78 extend between and connect with upper end portion 72 and lower end portion 74. Second pad element 58 includes a pad (not shown) covered by material (not separately labeled). The pad may be formed from a variety of materials.

In a non-limiting example, seat back 40 may include a manual actuator 82 that releases first pad element 56 and second pad element 58. In a non-limiting example, when released, first pad element 56 may pivot about upper end 62 and second pad element 58 may pivot about upper end portion 72 creating a gap 86 between inner edge 66 and inner edge portion 76 as shown in FIG. 3. In a non-limiting example, a spring (not shown) may create a biasing force that causes first pad element 56 and second pad element 58 to move along two axes away from one another. In the non-limiting example shown, inner edge 66 and inner edge portion 76 are non-parallel. Gap 86 is designed to accommodate a helmet or HANS system worn by a driver.

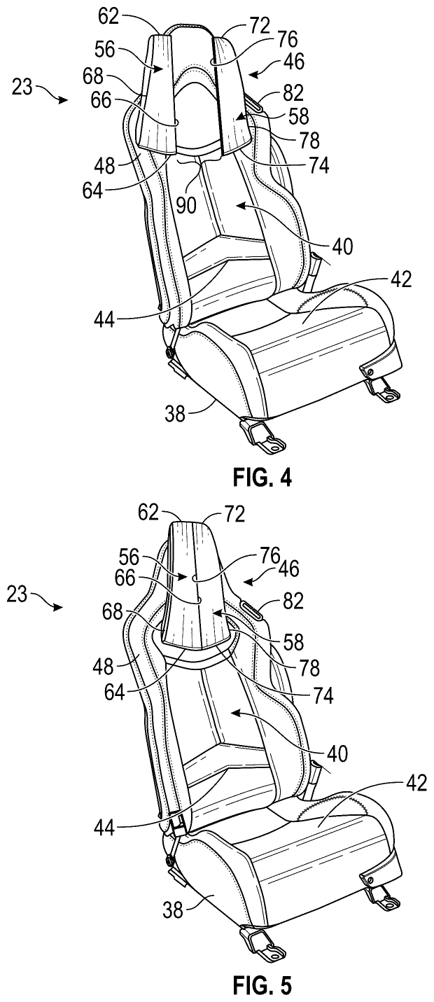

In a non-limiting example, when released by actuation of manual actuator 82, first pad element 56 and second pad element 58 may move outwardly relative to one another along a single axis as shown in FIG. 4. In the non-limiting example shown, a gap 90 is formed between first pad element 56 and second pad element 58. More specifically, gap 90 is defined between inner edge 66 and inner edge portion 76. In a non-limiting example, first pad element 56 and second pad element 58 move relative to one another such that inner edge 66 and inner edge portion 76 are parallel to one another. Gap 90 is designed to accommodate a helmet or HANS system worn by a driver.

In a non-limiting example, when released by actuation of manual actuator 82, first pad element 56 and second pad element 58 may move upwardly together as shown in FIG. 5. By moving upwardly together a space is created on adjustable top pad 46 which can accommodate a helmet or HANS system worn by a driver. When desired, as with any of the embodiments described so far, first pad element 56 and second pad element 58 may be manually returned to an initial, set position as shown in FIG. 2 and re-engaged by, for example, manual actuator 82.

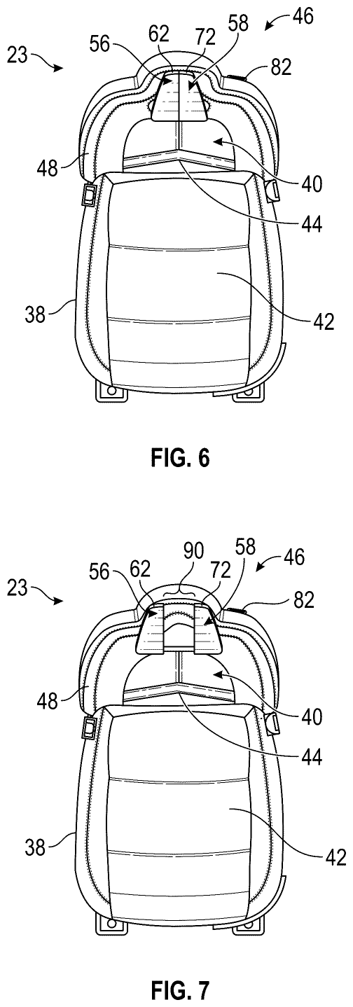

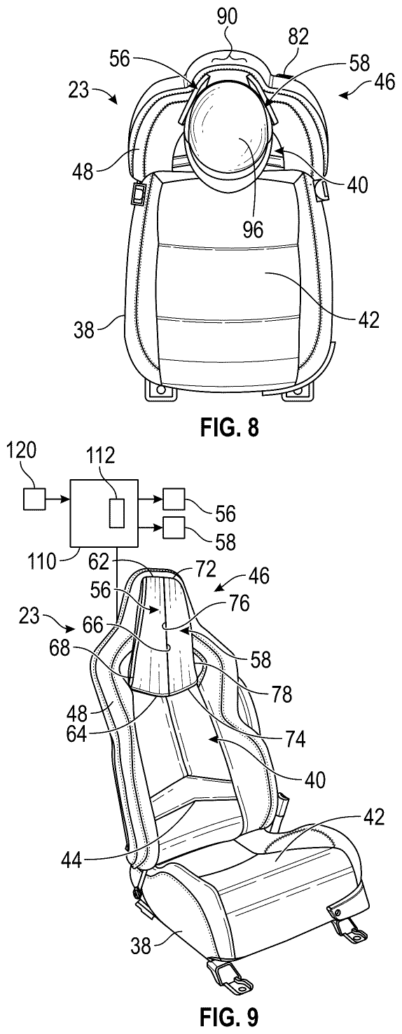

In a non-limiting example, first pad element 56 and second pad element 58 may move along a first axis from a set position (FIGS. 2 and 6) to a first adjustment position as shown in FIG. 7 in which inner edge 66 and inner edge portion 76 are separated from one another by gap 90. In a non-limiting example, first pad element 56 and second pad element 58 may then rotate outwardly as shown in FIG. 8. In this configuration, first pad element 56 and second pad element 58 may accommodate a helmet 96 with gap 90 accommodating a HANS system.

Reference will now follow to FIG. 9, wherein like reference numbers represent corresponding parts in the respective views, in describing a controller 110 that is connected to first pad element 56 and second pad element 58. Controller 110 may be connected to an actuator motor or linear actuator 112 that adjusts a position of first pad element 56 and second pad element 58 such as discussed herein. Controller 110 may be connected to an actuator 120 that may be mounted to seat 23. Actuator 120 may also be mounted to dashboard 26 or other locations in passenger compartment 20. Thus, it should be understood that the non-limiting examples described herein provide a headrest that can accommodate a helmeted driver, a driver wearing a HANS device, or both.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle seat comprising:
a seat base; and
a seat back connected to the seat base, the seat back including an adjustable top pad having a first pad element and a second pad element, the first pad element and the second pad element being selectively moveable to accommodate one of a head protection device and a neck protection device.

2. The vehicle seat according to claim 1, wherein the first pad element and the second pad element are selectively vertically shiftable on the seat back.

3. The vehicle seat according to claim 1, wherein the first pad element includes an upper end, a lower end, and inner edge, and an outer edge, and the second pad element includes an upper end portion, a lower end portion, an inner edge portion, and an outer edge portion, the first pad element being moveable relative to the second pad element along one axis.

4. The vehicle seat according to claim 3, wherein the first pad element is moveable relative to the second pad element along two axes.

5. The vehicle seat according to claim 4, wherein the first pad element and the second pad element are rotatable about the upper end and the upper end portion to separate the lower end and the lower end portion.

6. The vehicle seat according to claim 3, wherein the first pad element and the second pad element are shiftable along the seat back creating a gap between the inner edge and the inner edge portion.

7. The vehicle seat according to claim 6, wherein the first pad element and the second pad element is rotatable relative to the seat back creating the gap between the outer edge and the seat back and the outer edge portion and the seat back.

8. The vehicle seat according to claim 1, further comprising a manual actuator connected to the adjustable top pad, the manual actuator releasing the first pad element and the second pad element to move along the seat back.

9. The vehicle seat according to claim 1, further comprising an adjustment controller operatively connected to the first pad element and the second pad element.

10. The vehicle seat according to claim 9, further comprising an actuator mounted to the vehicle seat, the actuator being connected to the adjustment controller to selectively shift the first pad element and the second pad element on the seat back.

11. A vehicle comprising:
a plurality of wheels;
a body supported by the plurality of wheels, the body including a passenger compartment; and
a seat arranged in the passenger compartment, the seat comprising:
a seat base; and
a seat back connected to the seat base, the seat back including an adjustable top pad having a first pad element and a second pad element, the first pad element and the second pad element being selectively moveable to accommodate one of a head protection device and a neck protection device.

12. The vehicle according to claim 11, wherein the first pad element and the second pad element are selectively vertically shiftable on the seat back.

13. The vehicle according to claim 11, wherein the first pad element includes an upper end, a lower end, and inner edge, and an outer edge, and the second pad element includes an upper end portion, a lower end portion, an inner edge portion, and an outer edge portion, the first pad element being moveable relative to the second pad element along one axis.

14. The vehicle according to claim 13, wherein the first pad element is moveable relative to the second pad element along two axes.

15. The vehicle according to claim 14, wherein the first pad element and the second pad element are rotatable about the upper end and the upper end portion to separate the lower end and the lower end portion.

16. The vehicle according to claim 13, wherein the first pad element and the second pad element are shiftable along the adjustable top pad creating a gap between the inner edge and the inner edge portion.

17. The vehicle according to claim 16, wherein the first pad element and the second pad element is rotatable relative to the seat back creating the gap between the outer edge and the seat back and the outer edge portion and the seat back.

18. The vehicle according to claim 11, further comprising a manual actuator connected to the adjustable top pad, the manual actuator releasing the first pad element and the second pad element to move along the seat back.

19. The vehicle according to claim 11, further comprising an adjustment controller operatively connected to the first pad element and the second pad element.

20. The vehicle according to claim 19, further comprising an actuator mounted to the vehicle seat, the actuator being connected to the adjustment controller to selectively shift the first pad element and the second pad element on the seat back.
